(19) United States
(12) Patent Application Publication
(10) Pub. No.: US 2008/0081114 A1
(43) Pub. Date: Apr. 3, 2008

(54) Apparatus and method for delivering uniform fluid flow in a chemical deposition system

(75) Inventors: William Johanson, Gilroy, CA (US); John Mazzocco, San Jose, CA (US); David Cohen, San Jose, CA (US); Thomas M. Pratt, San Jose, CA (US); Gary Lind, Paso Robles, CA (US); Peter Krotov, San Jose, CA (US)

Correspondence Address: BEYER WEAVER LLP, P.O. BOX 70250, OAKLAND, CA, 94612-0250, US

(73) Assignee: Novellus Systems, Inc.

(21) Appl. No.: 11/542,959

(22) Filed: Oct. 3, 2006

(51) Int. Cl. B05D 3/00; B05D 3/04

(52) U.S. Cl. 427/273; 427/348

(57) ABSTRACT

Uniform fluid delivery to a substrate is provider using a diffuser. The diffuser is designed with a series of fluid (gas and/or liquid) passages of equal effective length/flow resistance, such that as the fluid passes through the diffuser, the gas exits all areas at the same time and with the same mass flux. These passages may not be physically the same, however they have the same effective length and flow resistance. The diffuser can be implemented using single or multiple stacked layers, and from several to many passages. The net effect is a uniform gas curtain to the wafer. Since the passages through the diffuser are effectively the same, the uniform gas curtain to the wafer is not sensitive to the quantity of gas, the gas flow rate or the gas pressure. Additionally, a faceplate can optionally be used to smooth out any jet effects of the diffuser exit holes.

### BACKGROUND OF THE INVENTION

This invention pertains to apparatus and processes for conducting chemical depositions, and may find particular use in depositing a conformal film of dielectric material with a high degree of surface smoothness particularly suited to high aspect ratio gap fill applications in semiconductor device fabrication.

Conformal, uniform dielectric films have many applications in semiconductor manufacturing. In the fabrication of sub-micron integrated circuits (ICs) several layers of dielectric film are deposited. Four such layers are shallow trench isolation (STI), pre-metal dielectric (PMD), inter-metal dielectric (IMD) and interlayer dielectric (ILD). All four of these layers require dielectric films, such as silicon dioxide, that fill features of various sizes and have uniform film thicknesses across the wafer.

In particular, it is often necessary in semiconductor processing to fill a high aspect ratio gap with insulating material. As device dimensions shrink and thermal budgets are reduced, void-free filling of high aspect ratio (AR) spaces (AR>3.0:1) becomes increasingly difficult due to limitations of existing deposition processes. The deposition of doped or undoped silicon dioxide by high density plasma CVD, a directional (bottom-up) CVD process, is the method currently preferred for high aspect ratio (AR) gap-fill in semiconductor fabrication production processes. Evolving semiconductor device designs and dramatically reduced feature sizes have resulted in several applications where HDP processes are challenged in filling the high aspect ratio structures (AR>7:1) using existing technology (see, for example, U.S. Pat. No. 6,030,881). For structures representative of the 65 nm and 45 nm technology nodes and beyond, engineering the gap-fill process becomes structure dependent, hence the process requires re-optimization, a task of considerable complexity, every time a new structure needs to be filled.

An alternative to CVD is atomic layer deposition (ALD). ALD methods involve self-limiting adsorption of reactant gases and can provide thin, conformal dielectric films within high aspect ratio features. The ALD process involves exposing a substrate to alternating doses of, usually two, reactant gasses. As an example, if reactants A and B are first and second reactant gases for an ALD process, after A is adsorbed onto the substrate surface to form a saturated layer, B is introduced and reacts only with adsorbed A. In this manner, a very thin and conformal film can be deposited. One drawback, however, to ALD is that the deposition rates are very low. The saturated layers produced by ALD are also very thin (i.e., about one monolayer); therefore, numerous ALD cycles must be repeated to adequately fill a gap feature. These processes are unacceptably slow in some applications in the manufacturing environment.

Another more recently developed technique useful in gap fill and other dielectric deposition applications in semiconductor processing is referred to as pulsed deposition layer (PDL) processing, sometimes also referred to as rapid surface-catalyzed vapor deposition (RVD). PDL is similar to ALD in that reactant gases are introduced alternately over the substrate surface, but in PDL the first reactant A acts as a catalyst, promoting the conversion of the second reactant B to a film. In ALD the reaction between A and B is approximately stoichiometric, meaning that a monolayer of A can only react with a similar amount of B before the film-forming reaction is complete. The catalytic nature of reactant A in PDL allows a larger amount of B to be added, resulting in a thicker film. Thus, PDL methods allow for rapid film growth similar to using CVD methods but with the film conformality of ALD methods.

PDL-type processes for forming silicon-based dielectrics can use as reactant A metal and metalloid catalysts (e.g., trimethylaluminum (TMA)) or metal- and metalloid-free catalysts (e.g., an organic acid such as acetic acid (CH₃COOH) or an inorganic acid such as phosphoric acid (H₃PO₄)); and as reactant B, a silicon-containing dielectric precursor. As an example of the use of PDL to deposit silicon dioxide on silicon, the first (catalytic) reagent can be trimethylaluminum (TMA) and the second (silicon-containing) reagent can be tris(pentoxy)silanol (TPOSL). A heated silicon substrate is first exposed to a dose of TMA, which is thought to react with the silicon surface to form a thin layer of surface-bound aluminum complex. Excess TMA is pumped or flushed from the deposition chamber and the wafer is transferred to a separate deposition chamber, or in the case of a multi-station chamber, a separate station of the chamber. The substrate is then exposed to a dose of TPOSL. The aluminum complex catalyzes the conversion of the silanol to silicon oxide until the silanol is consumed, or the growing film covers or otherwise inactivates the catalytic complex. When excess silanol is used, the film growth is usually self-limiting and a thick and uniform film results. Unreacted silanol is then removed from the chamber and the growth cycle repeated.

The most significant difference between CVD and PDL or ALD is that in the latter the catalyst and silicon-containing precursors are not present in the reactor at the same time. Instead, they are introduced sequentially, generally with a purging and/or pumping and/or wafer transfer step in between to minimize gas-phase reactions and to improve step coverage and uniformity of the film. Most commonly, the wafer is moved from station 1 where it is exposed to reactant A to station 2 where it is exposed to reactant B. In this way, the two reactants are never present at the same station in the reactor.

In some such film deposition systems, vaporized precursor gas flows from the liquid delivery system through a showerhead, into a deposition microvolume, and deposits on the wafer. The deposition is extremely rapid, and therefore the transient flux when the precursor is first introduced is important to the uniformity of the deposition. The fluid flux is defined as the rate of fluid flow across a unit area. It is generally optimal for all parts of the wafer to be exposed to equal flux of precursor, especially during the initial filling of the microvolume.

It is therefore desirable to develop methods and apparatus for uniform fluid delivery to a substrate, thereby improving the quality of the resulting deposited film.

### SUMMARY OF THE INVENTION

The present invention provides an apparatus and method for uniform fluid delivery to a substrate using a diffuser. The diffuser is designed with a series of fluid (gas and/or liquid) passages of equal effective length/flow resistance, such that as the fluid passes through the diffuser, the gas exits all areas at the same time and with the same mass flux. These passages may not be physically the same, however they have the same effective length and flow resistance. The diffuser can be implemented using single or multiple stacked layers, and from several to many passages. The net effect is a uniform gas curtain to the wafer. Since the passages through the diffuser are effectively the same, the uniform gas curtain to the wafer is not sensitive to the quantity of gas, the gas flow rate or the gas pressure. Additionally, a faceplate can optionally be used to smooth out any jet effects of the diffuser exit holes.

In one aspect, the invention relates to an apparatus for delivering fluid flow to a substrate. The apparatus has a showerhead comprising a fluid injection inlet and a diffuser located at a distil end of the fluid injection inlet relative to a fluid source. The diffuser has a plurality of fluid passages connecting X injection points to Y exit points, where Y>X and the plurality of fluid passages have substantially equal effective flow resistance. The apparatus can be integrated into a chemical deposition system further comprising a substrate for film deposition, and wherein the fluid passage configuration is such that during operation of the system a targeted portion of the substrate surface is exposed to a substantially uniform mass flux.

In another aspect, the invention relates to a method of depositing a film from a fluid precursor. The method involves providing in a film deposition system, a substrate for film deposition, and delivering a film precursor fluid to the substrate surface via a diffuser, the diffuser comprising a plurality of fluid passages connecting X injection points to Y exit points, where Y>X and the plurality of fluid passages have substantially equal effective flow resistance.

These and other features of the invention will be further described and exemplified in the drawings and detailed description below.

### BRIEF DESCRIPTION OF THE DRAWINGS

FIG. 1 is a schematic cross-sectional diagram showing relevant basic features of a chemical deposition station with which a diffuser in accordance with the present invention can be implemented.

FIG. 2 is a schematic perspective diagram showing relevant features of a single stage diffuser in accordance with the present invention.

FIGS. 3A-C show a multiple stage diffuser in accordance with one embodiment of the present invention from various perspectives.

FIG. 4 is a cross-section conceptual view of a multiple stage diffuser 400 in accordance with the present invention.

FIG. 5 illustrates a relevant portion of a diffuser in accordance with one embodiment of the present invention showing exit points with a conical profile.

FIG. 6 is a plot illustrating the uniformity of dielectric layers deposited with and without a diffuser in accordance with the present invention.

### DETAILED DESCRIPTION OF SPECIFIC EMBODIMENTS

In the following detailed description of the present invention, numerous specific embodiments are set forth in order to provide a thorough understanding of the invention. However, as will be apparent to those skilled in the art, the present invention may be practiced without these specific details or by using alternate elements or processes. In other instances, well-known processes, procedures and components have not been described in detail so as not to unnecessarily obscure aspects of the present invention.

Introduction

As indicated, the present invention provides an apparatus and associated method for conducting a chemical deposition. The apparatus and method are particularly applicable to use in conjunction with a semiconductor fabrication based dielectric deposition process that requires separation of self-limiting deposition steps in a multi-step dielectric deposition process (e.g., pulsed layer deposition (PDL) processing for catalyst and silicon precursor deposition), however they are not so limited and can be used with other chemical deposition techniques and in other application where uniform delivery of a fluid (in a gaseous or liquid state) to a substrate surface is desired. In some instances, the apparatus and process of the invention are described below with reference to PDL embodiments. However, it should be understood that the invention is not necessarily so limited.

Generally, a PDL process involves sequentially depositing a plurality of atomic-scale films on a substrate surface by sequentially exposing and removing reactants to and from the substrate surface. An exemplary case of PDL processing using reactant gases A and B will now be used to illustrate principle operations of a PDL process in accordance with the present invention. First, gas A is injected into a chamber and the molecules of gas A are chemically or physically adsorbed to the surface of a substrate, thereby forming a “saturated layer” of A. Formation of a saturated layer is self-limiting in nature and represents a thermodynamically distinct state of adsorbed A on a surface. In some cases, a saturated layer is only one monolayer. In other cases, a saturated layer is a fraction of a monolayer, or some multiple of monolayers.

After a saturated layer of A is formed, typically, the remaining gas A in the chamber is purged using an inert gas and/or pumped using a vacuum pump. Thereafter, the gas B is injected so that it comes in contact with the adsorbed layer of A and reacts to form a reaction product of A and B. Because the saturated layer of A is nominally thin and evenly distributed over the substrate surface, excellent film step coverage (i.e., conformal films) can be obtained. B is flowed over the substrate for a period of time sufficient to allow the reaction between A and B to preferably go to completion; i.e., all of the adsorbed A is consumed in the reaction. In a PDL process, B is flowed over the substrate for a period of time sufficient for a large enough quantity of B to be exposed to the substrate, resulting in a film formation in excess of one monolayer. After a desired quantity of B is delivered, the flow of B is stopped. There may be an optional soak time after stopping the delivery of B, to allow enough time to fully complete the reaction. At this point, residual gas B and any byproducts of the reaction are purged and/or pumped from the chamber. Further PDL cycles of substrate exposure to A, followed by exposure to B, can be implemented and repeated as needed for multiple layers of material to be deposited. Another deposition technique related to PDL is atomic layer deposition (ALD). PDL and ALD are both surface-controlled reactions involving alternately directing the reactants over a substrate surface. Conventional ALD, however, depends on self-limiting typically monolayer-producing reactions for both reactant gases. As an example, if reactants C and D are first and second reactant gases for an ALD process, after C is adsorbed onto the substrate surface to form a saturated layer, D is introduced and reacts only with adsorbed C. In this manner, a very thin and conformal film can be deposited. In PDL, as previously described using exemplary reactants A and B, after A is adsorbed onto the substrate surface, B reacts with adsorbed A and is further able to react to accumulate a self-limiting, but much thicker than one monolayer film. Thus, as stated previously, the PDL process allows for rapid film growth similar to using CVD methods but with the conformality of ALD methods.

PDL methods are related to the well-established chemical vapor deposition (CVD) techniques. However, in CVD, the chemical reactant gases are simultaneously introduced in a reaction chamber and allowed to mix and chemically react with each other in gas phase. The products of the mixed gases are then deposited on the substrate surface. Thus, PDL processing methods differ from CVD since in PDL the chemical reactant gases are individually injected into a reaction chamber and not allowed to mix prior to contacting the substrate surface. That is, PDL is based on separated surface-controlled reactions.

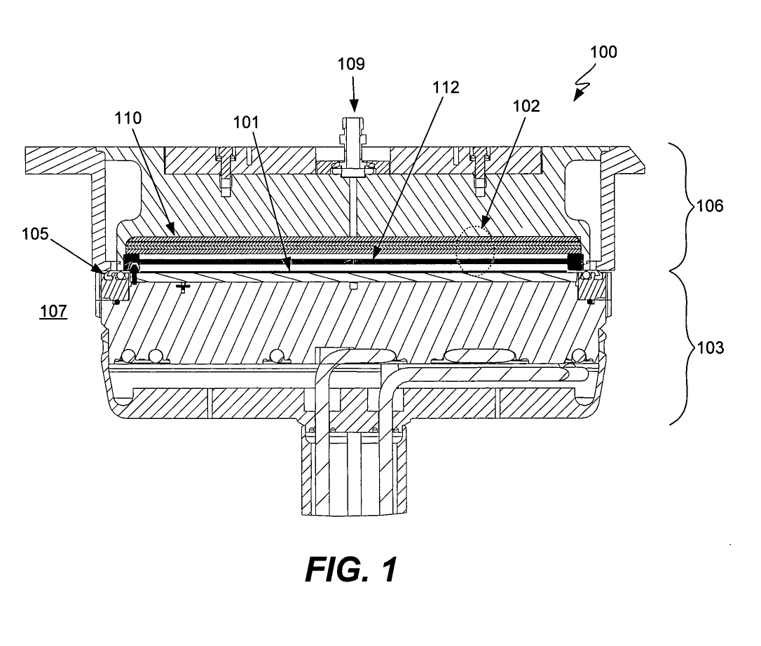

FIG. 1 is a schematic cross-sectional diagram showing relevant basic features of a chemical deposition system station suitable for conducting PDL, in accordance with which the present invention can be implemented. The station 100 has a vacuum/flow environment around a region 102 where the deposition substrate (e.g., wafer) 101 is positioned during exposure to chemical reactants that is within but separate from the main reactor volume 107. This region 102 is defined by walls composed of the inner surfaces of a module that supports the substrate and a module that provides the chemical reactants, and is referred to herein as a “microvolume” 102. This is generally accomplished by having the wafer 101 on a moving pedestal module 103 that can be raised or lowered relative to a showerhead module 106 to either close or open the station. Alternatively, the station can be opened or closed by raising or lowering the showerhead module 106 or by movement of both the pedestal and the showerhead modules. A hinged configuration is also possible.

The station 100 generally includes a seal 105 at the point of engagement of the pedestal 103 and showerhead 106 modules to facilitate station closure. While closed, there can be a separate flow of precursors to and a separate vacuum evacuation from the deposition region, the microvolume 102. Fluid chemical reactants, such as precursors or catalysts for dielectric or other films, are introduced into the microvolume from a source (or sources) via an injection inlet 109. An advantage of this configuration is that the total volume inside the station 100 is much smaller than the main reactor volume. For example, using a 2-3 mm gap between the wafer and the lower surface of the showerhead and a 300 mm wafer, the total volume of the station may be less than about 0.25 L.

In accordance with the present invention, a diffuser 110 is located at the distil end of the fluid injection inlet 109 relative to the fluid source. The diffuser 110 is an apparatus having a plurality of fluid passages between the distil end of the fluid injection inlet 109 and the microvolume 102 where the substrate 101 to which fluid reactants are to be delivered resides. In specific embodiments, the substrate 101 is a semiconductor wafer and the fluids reactants are precursor gases for a film to be formed on the substrate, such as a dielectric film in a blanket dielectric deposition or gap fill operation. The fluid passages of the diffuser 110 connect one or more injection points to a greater number of exit points (X injection points to Y exit points where Y>X). The plurality of fluid passages have substantially equal effective flow resistance. That is, the plurality of fluid passages are configured such that fluids (gases or liquids) entering the diffuser 110 have the same residence time; fluids entering the diffuser together are evenly distributed across the plurality of passages and exit the diffuser together with the substantially same mass flux at each exit point. This is the case under all flow conditions, including subsonic, transient, and supersonic. In this way, the diffuser 110 uniformly distributes materials, in the process chamber of the integrated circuit manufacturing equipment for example.

In operation of a chemical deposition (film deposition) system, the diffuser 110 is engaged with the showerhead module 106 and above the substrate (e.g., wafer) 101, which is located in the pedestal module 103. The showerhead module 106 may also optionally include a faceplate 112 located between the diffuser 110 and the pedestal module 103/wafer 101. The faceplate 112 has uniformly distributed holes configured to enhance uniform flux of fluid exiting the diffuser exit holes. Both the diffuser 110 and the optional faceplate 112 optimally configured so that their diameters match the diameter of the wafer 101. This facilitates uniform material delivery throughout the microvolume 102 and thus to the wafer surface, although it may not always be the case

The diffuser 110, optional faceplate 112 and other components of the apparatus and system may be made of any suitable material(s), such as are known in the art. In particular, the diffuser 110 and faceplate 112 may be made of metal, ceramic or polymeric materials with physical and chemical properties suitable for the chemical deposition environment. Aluminum is one such suitable material.

Fluid material, such as a dielectric precursor gas, enters the showerhead 106 though the injection inlet 109 and flows into the diffuser 110, spreading between multiple passages. As the fluid progresses through the diffuser passages the pressure gradually decreases. This gradual reduction in fluid material pressure from stage to stage renders the apparatus less susceptible to the material passage cross-talk (material leakage from a high pressure fluid passage to a low pressure fluid passage) and facilitates uniform distribution of the fluid exiting the diffuser 110 which leads to uniform mass flux to the microvolume 102 above the substrate target area. The diffuser may comprise one (a single layer) or multiple (a plurality of stacked layers) layers of material to form the passages.

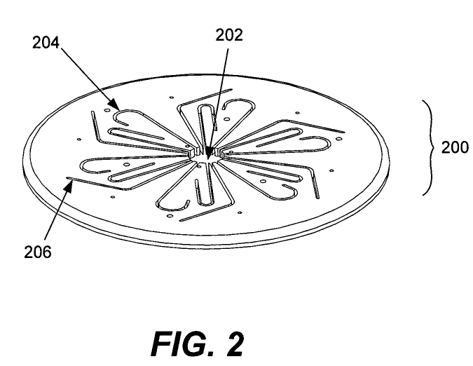

FIG. 2 illustrates an example of a single stage diffuser in accordance with the present invention. The single stage diffuser 200 has a single fluid (e.g., precursor gas) injection point 202 with inlets to a plurality of fluid channels or passages 204, each channel terminating in an exit hole 206. As noted above, the fluid passages 204 have substantially equal effective flow resistance. That is, the pressure drop along the length of each passage is the same such that fluids (gases or liquids) entering the diffuser 200 have the same residence time; fluids entering the diffuser together are evenly distributed across the plurality of passages and exit the diffuser together with the same mass flux at each exit point. Where the fluid is in the gas phase, the objective is for the gas to exit the diffuser as a uniform gas curtain under all conditions, including transient flow. The substantially equal effective flow resistance can be achieved using passages of identical length and shape, or as shown in the figure, with passages of different lengths and/or shapes properly configured. Given the parameters provided herein and basic knowledge of fluid mechanics, one of skill in the art will be able to readily determine appropriate fluid passage geometries and configurations to achieve substantially equal effective flow resistance in the passages of a diffuser in accordance with the invention.

In the embodiment illustrated in FIG. 2, a single fluid injection point 202 is provided. This is the case in many preferred embodiments. However, multiple injection points are also possible as long as the number of exit points 206 exceeds the number of injection points 202. While not limiting the invention, in general, the number of injection points is from about 1 to 10 and the number of exit points is from about 3 to 5000. In more specific embodiments, the number of injection points is from about 1 to 3 and the number of exit points is from about 10 to 1000. Even more specifically, a single injection point is used and the number of exit points is from about 50 to 100.

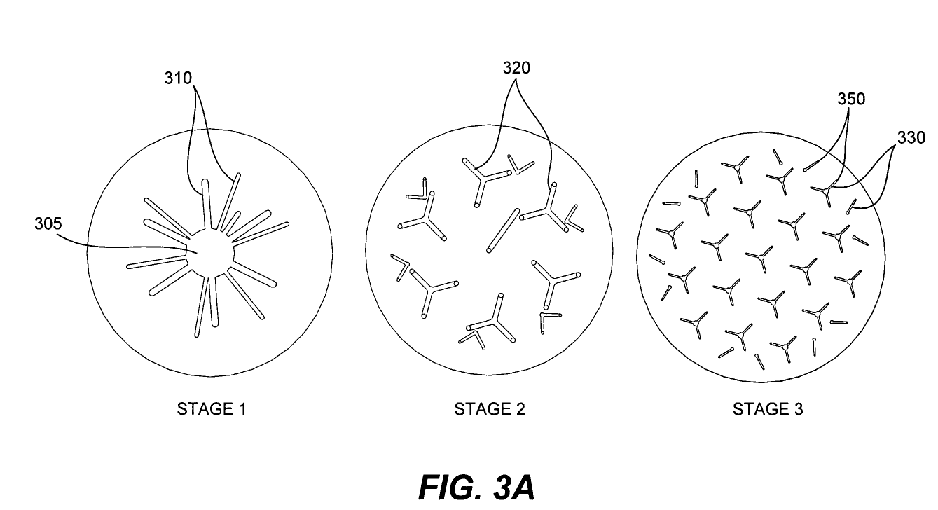

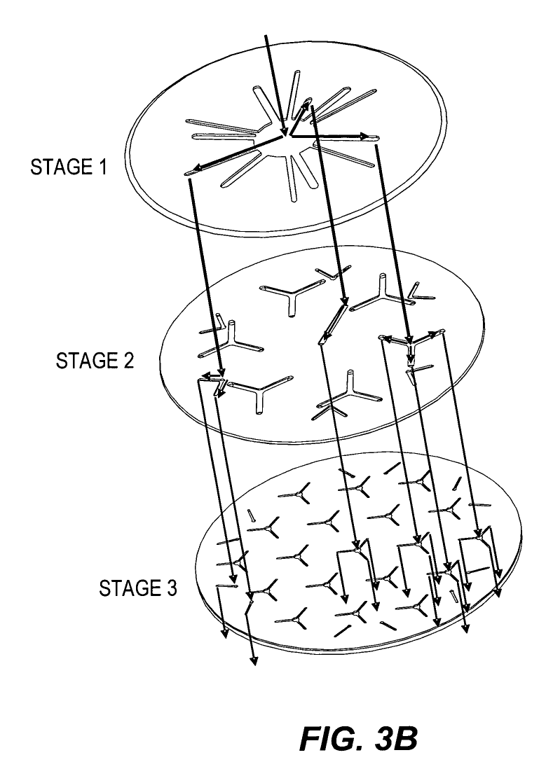

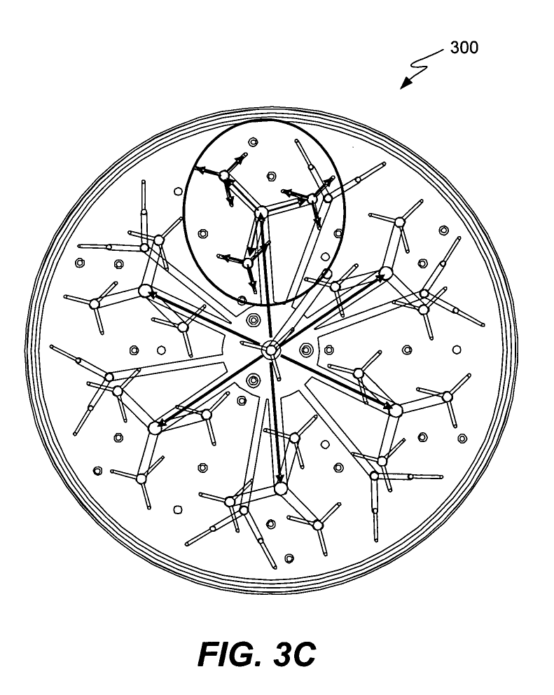

FIGS. 3A-C show an example of a multiple stage diffuser in accordance with the present invention. The multi stage diffuser design is shown from various perspectives in order to advantageously illustrate its features. The assembled diffuser 300 (FIG. 3C) has a symmetrical layout and the flow channels that distribute material through passages on three stages from a single injection point to 54 distribution holes in the final stage are substantially the same in terms of their effective flow resistance. In general, the channels may have any suitable shape; straight, or symmetrical, or curved, for example. The symmetrical approach to layout of the material passages results in uniform mass flux between all of the 54 distribution holes and across the process chamber under all flow conditions, including subsonic, transient, and supersonic.

FIG. 3A depicts a top plan view of each of the three stages of the multiple stage diffuser prior to assembly so that the flow channels on each stage can be clearly seen. Since the pressure decreases as the fluid moves through the diffuser, the three stages can be referred to as a high pressure stage (stage 1), a medium pressure stage (stage 2), and a low pressure stage (stage 3). Each diffuser stage has channels on a face to create passages for the fluid material. The passages on each stage are arranged so that when the diffuser stages are assembled together, the channels in one stage are covered by the flat surface of another stage to create a material passage.

Stage 1, the high-pressure stage, has a fluid material injection point 305 common to all the passages that ultimately exit through the exit holes 350 of low pressure stage 3 and several different passages 310 emanating from it. There are three different passage sizes to source flow to three effective areas, as shown in stages 2 and 3. The passage widths are different to accommodate a different amount of flow so that the flow to each of the different regions is substantially the same. Stage 2, the mid-pressure stage, has passages 320 that link the passages 310 of stage 1 to those 330 of stage 3, the high pressure stage. Stage 3 also has the distribution holes 350 from which the fluid exits the diffuser.

In this embodiment, the low-pressure stage 3 is designed to have substantially identical passage geometry to insure equal flow distribution under any flow conditions. To insure the material uniform flow distribution, all passages on this stage have equal shape, equal cross-section and equal length. The passages are straight (without bends and curves). In some embodiments, straight passages are preferred since this makes their conductance less susceptible to variations under all flow conditions. Straight passages are easier to design and cheaper to manufacture in comparison with bended and curved ones. Additionally, they may have more predictable flow characteristics. The distribution holes at the end of the passages have equal diameter. In other embodiments, the passage may have different geometry and the distribution holes may have different diameters as long as they have substantially equal effective flow resistance and deliver substantially equal mass flux.

FIG. 3B shows how the three stages of FIG. 3A come together to form the diffuser. The assembled layers are pressed together and held, for example by multiple screws. The diffuser assembly can include one or more dividers (gaskets) (not shown) adjacent to or between stages to prevent leaking from one fluid passage to another between the stacked stage layers. The fluid exits the diffuser through exit points (holes) in the low pressure stage 1. The passages may be straight or curved, but as with the single stage diffuser 200, are designed such that they have substantially equal effective flow resistance and deliver substantially equal mass flux.

The arrows illustrate the flow of fluid material through the stages of the diffuser in operation to show how the material is evenly distributed. A fluid material, such as a precursor gas, flows from the injection point 305 into inlets to each of the passages 310 in the high pressure stage 1. The fluid flows into the passages 310 through to the outlet holes at the end of the passages on that stage. When the material reaches the outlet hole of the passage in one stage (e.g., stage 1, high pressure), it flows through the hole into the next diffuser stage (e.g., stage 2, mid pressure), spreads between two or more passages and through holes into next diffuser stage (e.g., stage 3, low pressure). Ultimately, the fluid material exits the diffuser through distribution holes of the final stage (e.g., stage 3) equally spaced to insure the uniform material flux towards the substrate. The effect of the diffuser is that material entering the diffuser at the single injection point 305 in stage 1 cascades through the passages and leaves the diffuser at stage 3 uniformly distributed through the 54 distribution holes.

FIG. 3C depicts a transparent view of the assembled multistage diffuser, illustrating the interconnected passages on each stage forming the completed fluid passages through the diffuser 300.

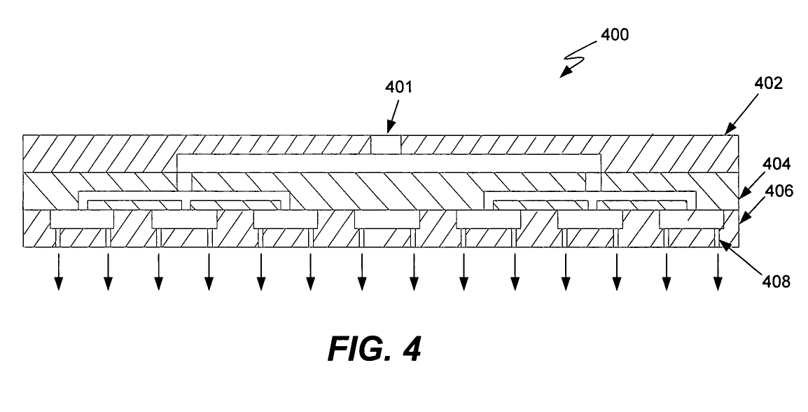

FIG. 4 is a cross-section conceptual view of a multiple stage diffuser 400 in accordance with the present invention, shown to further illustrate the principle of the branching of the passages at each layer to multiply the number of exit points relative to the initial injection point(s). The depicted diffuser 400 has three stages. In the figure it can be seen that a single injection point 401 in a first (high pressure) stage 402 connects to first stage passages that interface with passages on a second (mid pressure) stage 404, that in turn connect with pages on a third (low pressure) stage 406. The third stage 406 has fluid outlets 408 through which the fluid exits the diffuser.

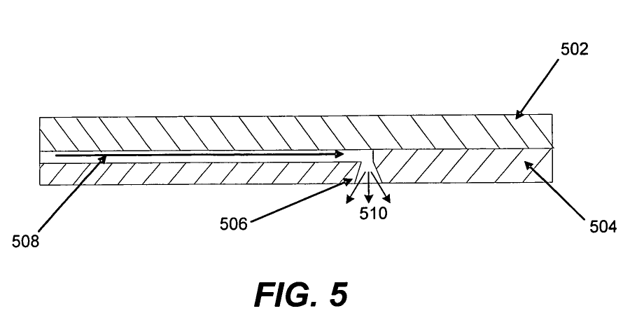

In the previously illustrated embodiments, the distribution holes in the low-pressure stage have a cylindrical shape. Such a geometry is acceptable in accordance with the present invention, particularly when a faceplate is used in conjunction with the diffuser. However, these holes may also be conically or otherwise shaped to minimize a jet effect of the exiting material and create a flow smoothing effect equivalent to the effect of a faceplate. FIG. 5 illustrates an embodiment of this aspect of the invention. An intermediate stage 502 and final stage 504 of a diffuser in accordance with the present invention are shown. The distribution holes 506 through which the fluid exits the diffuser have a conical profile. Material in the passages 508 exits the diffuser smoothly 510 without creating a jet effect.

As noted previously, a diffuser in accordance with the present invention may be optionally supplemented with a faceplate to smooth out the jet effect of the diffuser exit holes and further facilitate uniform fluid distribution from the diffuser. Such a faceplate has a large number of holes, much larger than the number of distribution holes exiting the diffuser (e.g., thousands of holes). Use of a faceplate can improve performance in some circumstances, but may not be necessary in others, such as where the jet effect of the distribution is addressed by tailoring the shapes of the holes (e.g., making them conical).

A diffuser in accordance with the present invention can be integrated into a film deposition system having a substrate for film deposition, for example a PDL system for depositing silicon-containing dielectric for gap fill in semiconductor processing. The fluid passage configuration is such that during operation of the system the substrate surface is exposed to a substantially uniform mass flux. In this embodiment, and others of this sort, the fluid flux can be a dielectric film precursor gas flux. In some implementations, the region of substantially uniform fluid flux may extend beyond the substrate surface, for example to address edge effects.

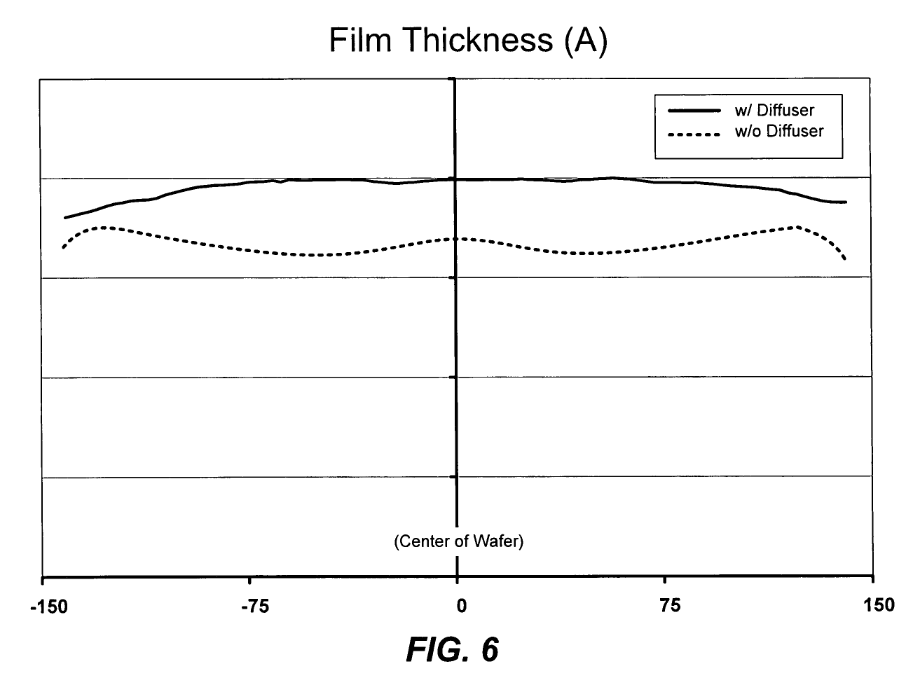

FIG. 6 is a plot illustrating the uniformity of dielectric layers deposited with and without a diffuser in accordance with the present invention. The plot illustrates an important advantage of the invention, namely improved WIW (within wafer) uniformity of deposited material. The thickness profile for the material deposited with the diffuser is flatter than that of the material deposited without a diffuser demonstrating that the uniform distribution of material provides this beneficial result.

### CONCLUSION

The present invention provides a diffuser and associated apparatus and method of use that enables uniform fluid delivery to a substrate. The invention has particular benefit in chemical deposition applications where deposition is extremely rapid, and therefore the transient flux when a fluid reactant is first introduced is important to the uniformity of the deposition process. In such cases it is generally optimal for all parts of the wafer to be exposed to equal quantities of fluid reactant (e.g., dielectric precursor gas), especially during the initial filling of the deposition chamber (e.g., microvolume). Use of the apparatus and method of the present invention achieves this goal, thereby improving the quality of the resulting deposited film.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. For example, while the invention has been described primarily in terms of preparing integrated circuits, it is not so limited. Accordingly, the present embodiments are to be considered as illustrative and not restrictive, and the invention is not to be limited to the details given herein, but may be modified within the scope and equivalents of the appended claims.

All documents cited herein are hereby incorporated by reference in their entirety and for all purposes.

What is claimed is:

1. An apparatus for delivering fluid flow to a substrate, comprising:
a showerhead comprising a fluid injection inlet; and
a diffuser located at a distil end of the fluid injection inlet relative to a fluid source, the diffuser comprising,
a plurality of fluid passages connecting X injection points to Y exit points, where Y>X and the plurality of fluid passages have substantially equal effective flow resistance and deliver substantially equal mass flux.

2. The apparatus of claim 1, wherein the plurality of fluid passages comprise passages of equal length.

3. The apparatus of claim 1, wherein the plurality of fluid passages comprise passages of different lengths.

4. The apparatus of claim 1, wherein the plurality of exit points comprise holes of equal shape and diameter.

5. The apparatus of claim 1, wherein the plurality of exit point comprise holes of different shape or diameter.

6. The apparatus of claim 1, wherein 1≦X≦10 and 3≦Y≦5000.

7. The apparatus of claim 6, wherein 1≦X≦3 and 10≦Y≦1000.

8. The apparatus of claim 7, wherein X=1 and 50≦Y≦100.

9. The apparatus of claim 1, wherein the diffuser consists of a single layer.

10. The apparatus of claim 1, wherein the diffuser comprises a plurality of stacked diffuser stage layers.

11. The apparatus of claim 10, wherein the plurality of stage layers is 3.

12. The apparatus of claim 1, further comprising a faceplate having uniformly distributed holes configured to enhance uniform distribution of fluid exiting the diffuser exit holes.

13. The apparatus of claim 1, wherein the apparatus is integrated into a chemical deposition system further comprising a substrate for film deposition, and wherein the fluid passage configuration is such that during operation of the system the substrate surface is exposed to a substantially uniform fluid flow.

14. The apparatus of claim 1, wherein the apparatus operates under all flow conditions, including subsonic, transient, and supersonic.

15. The apparatus of claim 14, wherein the fluid flow is in a phase selected from the group consisting of gas, liquid and combinations thereof.

16. The apparatus of claim 15, wherein the fluid flow is in the gas phase.

17. The apparatus of claim 16, wherein the plurality of gas passages are configured such that during system operation gases exit the diffuser as a uniform gas curtain.

18. The apparatus of claim 1, wherein the plurality of fluid passage exit points have a cylindrical profile.

19. The apparatus of claim 1, wherein the plurality of fluid passage exit points have a conical profile.

20. A method of depositing a film from a fluid precursor, comprising:
providing in a film deposition system, a substrate for film deposition; and
delivering a film precursor fluid to the substrate surface via a diffuser, the diffuser comprising a plurality of fluid passages connecting X injection points to Y exit points, where Y>X and the plurality of fluid passages have substantially equal effective flow resistance and delivering substantially equal mass flux.

21. The method of claim 20, wherein the substrate surface is exposed to a substantially uniform mass flux.

22. The method of claim 20, wherein delivery of the film precursor fluid occurs under all flow conditions, including subsonic, transient, and supersonic.

23. The method of claim 20, wherein the fluid precursor is in a phase selected from the group consisting of gas, liquid and combinations thereof.

24. The method of claim 20, wherein the fluid precursor is in the gas phase.

25. The method of claim 24, wherein the plurality of gas passages are configured such that during system operation gases exit the diffuser as a uniform gas curtain.
